(19) United States
(12) Patent Application Publication
(10) Pub. No.: US 2012/0135643 A1
(43) Pub. Date: May 31, 2012

(54) Low-Cross-Talk Electrical Connector

(76) Inventors: Ludwig Lange, CT Nuland (NL); Paul Potters, Eindhoven (NL); Winnie Heyvaert, Brasschaat (BE)

(21) Appl. No.: 13/376,027

(22) PCT Filed: Jun. 3, 2010
(86) PCT No.: PCT/IB10/01939

§ 371 Date: Feb. 13, 2012

Related U.S. Application Data
(60) Provisional application No. 61/184,268, filed on Jun. 4, 2009.

(51) Int. Cl. H01R 24/28

(52) U.S. Cl. 439/660

(57) ABSTRACT

An electrical connector includes a first contact module and a second contact module adjacent the first contact module. Each contact module has a plurality of ground and signal contacts. Each ground contact and signal contact includes a mating portion, a mounting portion, and an intermediate portion extending between the mating portion and the mounting portion. In each contact module, the intermediate portions of the ground contacts are disposed in a first common plane and the intermediate portions of the signal contacts are disposed in a second common plane that is spaced from the first common plane. The first contact modules and the second contact modules are arranged such that two adjacent signal contacts of the first and second contact modules, respectively, define a differential signal pair such that the intermediate portions of the adjacent signal contacts are spaced more closely than the intermediate portions of two adjacent ground contacts of the first and second contact modules, respectively.

### CROSS-REFERENCE TO RELATED APPLICATIONS

This application claims the benefit of U.S. provisional patent application Ser. No. 61/184,268 filed on Jun. 4, 2009, the disclosure of which is hereby incorporated by reference as if set forth in its entirety herein.

### TECHNICAL FIELD

The present disclosure relates generally to the field of electrical connectors, and in particular relates to an electrical connector that is configured to reduce cross-talk between adjacent signal contacts.

### BACKGROUND

Electrical connectors provide signal connections between electronic devices using electrically-conductive contacts, or electrical contacts. In some applications, an electrical connector provides a connectable interface between one or more substrates, e.g., printed circuit boards. Such an electrical connector may include a receptacle connector mounted to a first substrate and a complementary header connector mounted to a second substrate. Typically, a first plurality of electrical receptacle contacts in the receptacle connector is adapted to mate with a corresponding plurality of electrical header contacts in the header connector. For instance, the electrical receptacle contacts can receive the electrical header contacts so as to establish an electrical connection between the electrical receptacle contacts and the electrical header contacts.

The electrical contacts typically include a plurality of signal contacts and ground contacts. Often, the signal contacts are so closely spaced that undesirable interference, or “cross talk,” occurs between adjacent signal contacts. As used herein, the term “adjacent” refers to contacts (or rows or columns) that are next to one another. Cross talk occurs when one signal contact induces electrical interference in an adjacent signal contact due to intermingling electrical fields, thereby compromising signal integrity. With electronic device miniaturization and high speed, high signal integrity electronic communications becoming more prevalent, the reduction of cross talk becomes a significant factor in connector design.

One commonly used technique for reducing cross talk is to position separate electrical shields, in the form of metallic plates, for example, between adjacent signal contacts. The shields act to block cross talk between the signal contacts by blocking the intermingling of the contacts' electric fields. The ground contacts are also frequently used to block cross talk between adjacent differential signal pairs.

Because of the demand for smaller, lower weight communications equipment, it is desirable that connectors be made smaller and lower in weight, while providing the same performance characteristics. Shields take up valuable space within the connector that could otherwise be used to provide additional signal contacts, and thus limit contact density (and, therefore, connector size). Additionally, manufacturing and inserting such shields substantially increase the overall costs associated with manufacturing such connectors. In some applications, shields are known to make up 40% or more of the cost of the connector. Another known disadvantage of shields is that they lower impedance. Thus, to make the impedance high enough in a high contact density connector, the contacts would need to be so small that they would not be robust enough for many applications.

It is desirable to provide an electrical connector that occupies a minimum amount of substrate space while reducing the occurrence of cross talk between the signal contacts of the electrical connector.

### SUMMARY

In accordance with one embodiment, an electrical connector includes a first contact module and a second contact module adjacent the first contact module. Each contact module has a plurality of ground and signal contacts. Each ground contact and signal contact includes a mating portion, a mounting portion, and an intermediate portion extending between the mating portion and the mounting portion. In each contact module, the intermediate portions of the ground contacts are disposed in a first common plane and the intermediate portions of the signal contacts are disposed in a second common plane that is spaced from the first common plane. The first contact modules and the second contact modules are arranged such that two adjacent signal contacts of the first and second contact modules, respectively, define a differential signal pair such that the intermediate portions of the adjacent signal contacts are spaced more closely than the intermediate portions of two adjacent ground contacts of the first and second contact modules, respectively.

### BRIEF DESCRIPTION OF THE DRAWINGS

FIG. 1A is a perspective view of an electrical connector system constructed in accordance with one embodiment including a first electrical connector and a second electrical connector configured to be electrically connected to first and second respective substrates;

FIG. 1B is a perspective view of the first electrical connector illustrated in FIG. 1A, including a connector housing and a plurality of electrical contacts supported by the connector housing;

FIG. 1C is a perspective view of a portion of the first electrical connector illustrated in FIG. 1B with the housing removed, showing a plurality of contact modules that retain the electrical contacts;

FIG. 1D is a perspective view of the second electrical connector illustrated in FIG. 1A;

FIG. 1E is another perspective view of the second electrical connector illustrated in FIG. 1A;

FIG. 1F is a sectional side elevation view of the electrical connector assembly illustrated in FIG. 1A, showing the first electrical connector mated to the second electrical connector;

FIG. 2A is a perspective view of a first one of the contact modules illustrated in FIG. 1C, including a first leadframe assembly and a second leadframe assembly;

FIG. 2B is an exploded view of the first contact module illustrated in FIG. 2A, including a first leadframe assembly having a first leadframe housing that retains a first plurality of electrical contacts, and a second leadframe assembly having a second leadframe housing that retains a second plurality of electrical contacts;

FIG. 3A is a perspective view of the first contact module illustrated in FIGS. 2A-B, with the first and second leadframe housings removed to reveal the first and second pluralities of electrical contacts;

FIG. 3B is a sectional side elevation view of the first contact module illustrated in FIG. 3A, taken along line 3B-3B;

FIG. 3C is a bottom plan view of the of the first contact module illustrated in FIG. 3A;

FIG. 3D is a front elevation view of the first contact module illustrated in FIG. 3A;

FIG. 4A is a perspective view of the first contact module illustrated in FIG. 3A, but showing the first and second pluralities of electrical contacts constructed in accordance with an alternative embodiment;

FIG. 4B is a sectional side elevation view of the first contact module illustrated in FIG. 4A, taken along line 4B-4B;

FIG. 4C is a bottom plan view of the contact module illustrated in FIG. 4A;

FIG. 5A is a perspective view of a second one of the contact modules illustrated in FIG. 1C, including a third leadframe assembly and a fourth leadframe assembly;

FIG. 5B is an exploded view of the first contact module illustrated in FIG. 5A, including the third leadframe assembly having a third leadframe housing that retains the first plurality of electrical contacts such that the first plurality of electrical contacts have a different placement in the third leadframe housing than in the first leadframe housing illustrated in FIG. 2B, and the fourth leadframe assembly having a fourth leadframe housing that retains the second plurality of electrical contacts such that the second plurality of electrical contacts have a different placement in the fourth leadframe housing than in the second leadframe housing illustrated in FIG. 2B;

FIG. 6A is a perspective view of the second contact module illustrated in FIGS. 5A-B, with the third and fourth leadframe housings removed to reveal the third and fourth pluralities of electrical contacts;

FIG. 6B is a sectional side elevation view of the second contact module illustrated in FIG. 6A, taken along line 6B-6B;

FIG. 6C is a bottom plan view of the of the second contact module illustrated in FIG. 6A;

FIG. 6D is a front elevation view of the second contact module illustrated in FIG. 6A;

FIG. 7A is a perspective view of the second contact module illustrated in FIG. 6A, but showing the third pluralities of electrical contacts constructed in accordance with an alternative embodiment;

FIG. 7B is a sectional side elevation view of the second contact module illustrated in FIG. 7A, taken along line 7B-7B;

FIG. 7C is a bottom plan view of the contact module illustrated in FIG. 7A;

FIG. 8 is a sectional front elevation view of the first electrical connector illustrated in FIG. 1B showing a mating interface;

FIG. 9A is a sectional front elevation view of the contact modules illustrated in FIG. 1C, showing the first and second contact modules illustrated in FIGS. 2A and 5A in a first contact configuration;

FIG. 9B is a schematic view of the of the first and second pluralities of electrical contacts of the contact modules illustrated in FIG. 9A;

FIG. 10A is a sectional front elevation view of the contact modules illustrated in FIG. 1C, showing the first and second contact modules illustrated in FIGS. 2A and 5A in a second contact configuration that is different than the first configuration illustrated in FIG. 9A; and

FIG. 10B is a schematic view of the first and second pluralities of electrical contacts of the contact modules illustrated in FIG. 10A.

### DETAILED DESCRIPTION

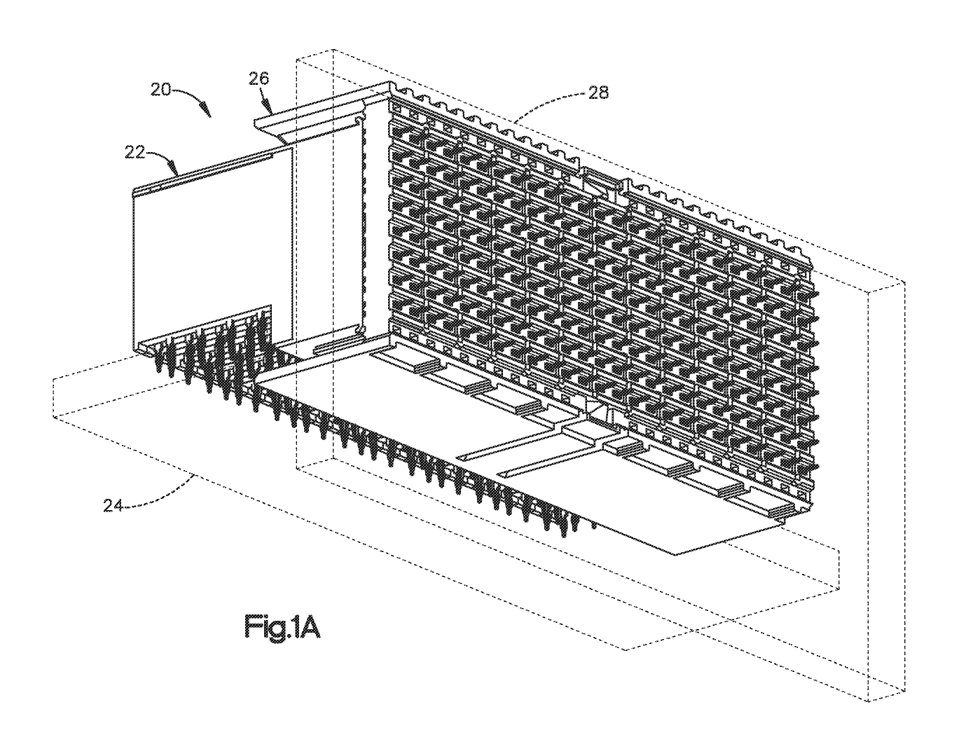

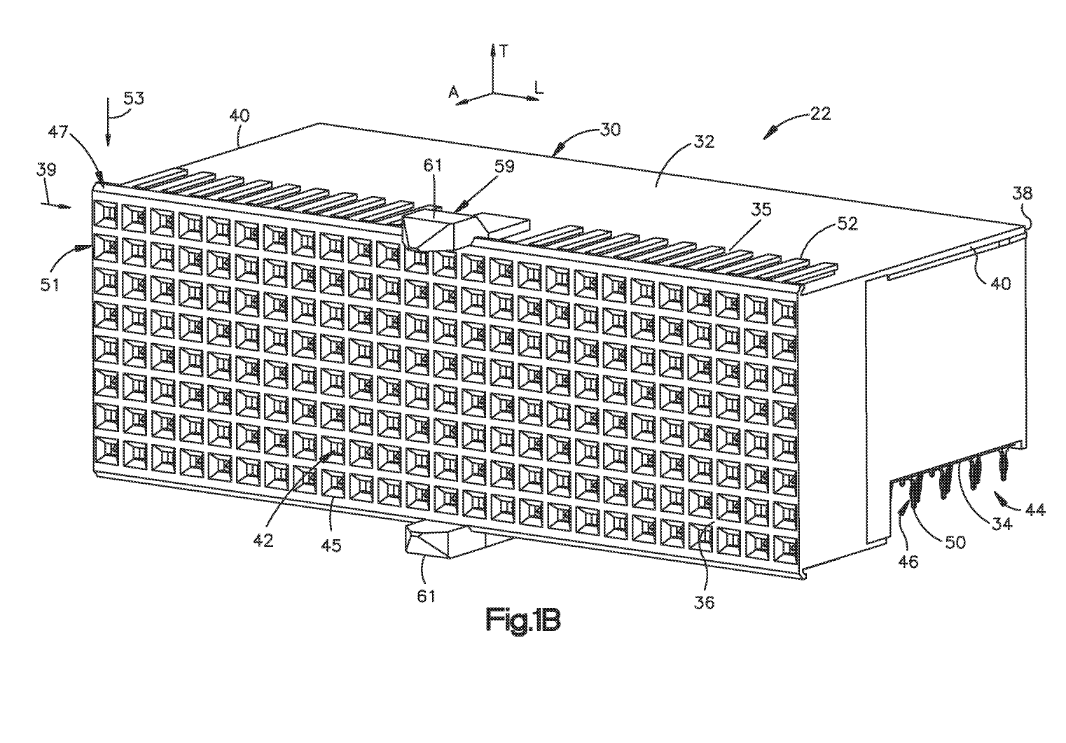

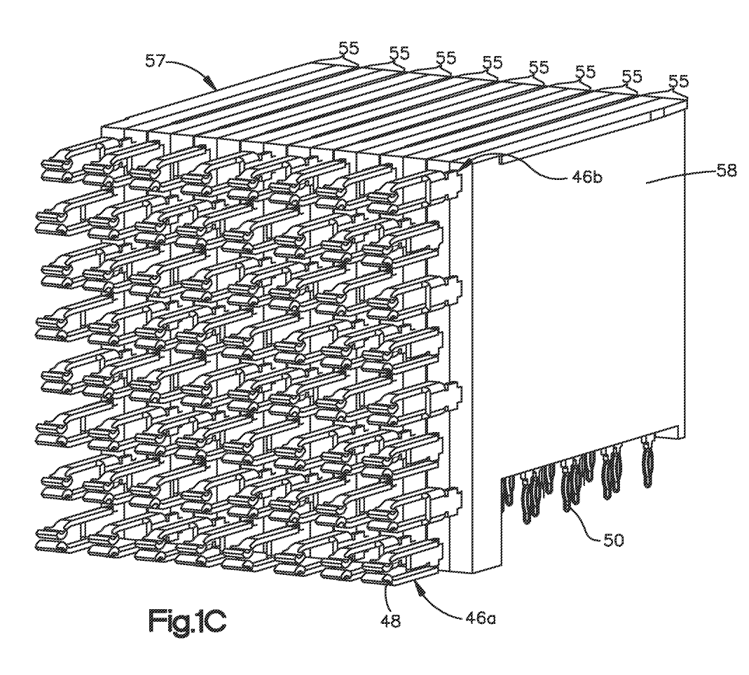

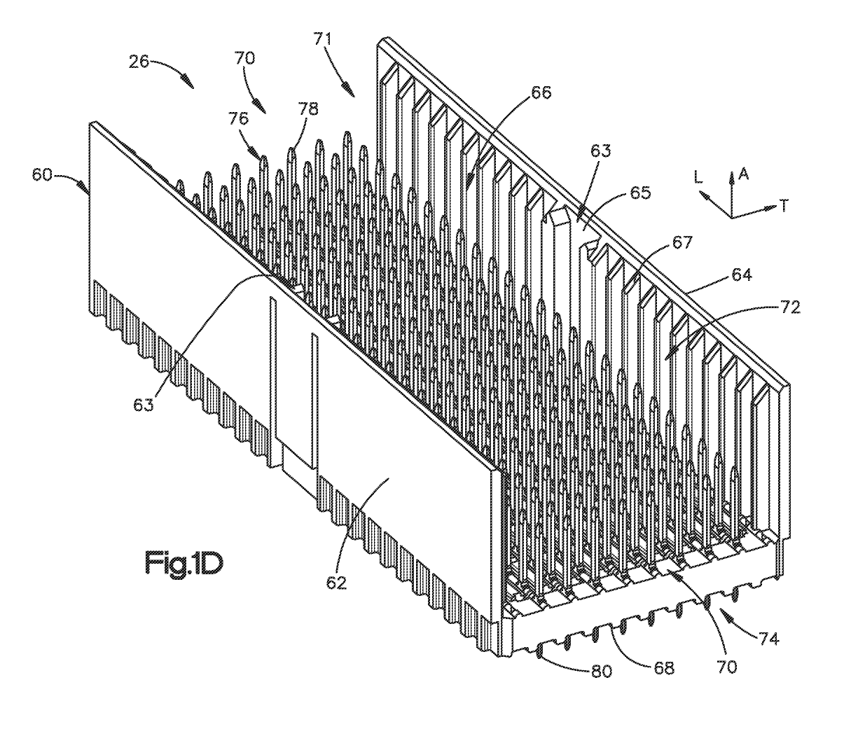

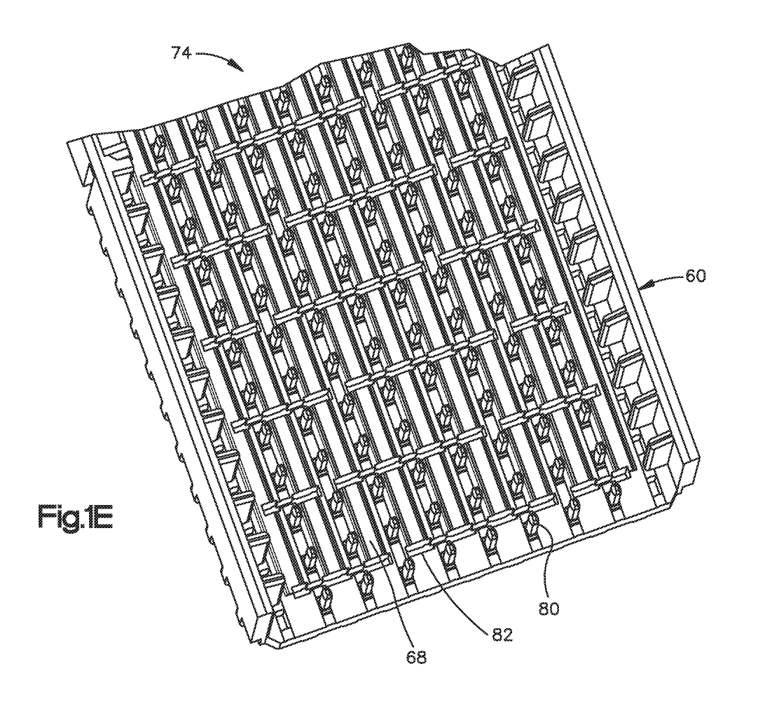

Referring to FIG. 1A, an electrical connector system 20 includes a first electrical connector 22 configured to be electrically connected to a first substrate 24 which can be provided as a printed circuit board (PCB), and a second electrical connector 26 configured to be electrically connected to a second substrate 28 such as a PCB. The first and second electrical connectors 22 and 26 are configured to mate with each other so as to place the first and second substrates 22 and 26 in electrical communication with each other.

Referring also to FIG. 1B, the first electrical connector 22 includes a connector housing 30 that is dielectric or electrically insulative, and defines a top end 32, an opposing bottom end 34, a front end 36, an opposing rear end 38, and opposing sides 40. The opposed sides 40 are spaced apart along a longitudinal direction L, the front and rear ends 36, 38 are spaced apart along a lateral direction A that is substantially perpendicular with respect to the longitudinal direction L, and the top and bottom ends 32 and 34 are spaced apart along a transverse direction T that is substantially perpendicular with respect to the lateral direction A and the longitudinal direction L. In accordance with the illustrated embodiment, the transverse direction T is oriented vertically, and the longitudinal and lateral directions L and A are oriented horizontally, though it should be appreciated that the orientation of the connector housing 30 may vary during use. In accordance with the illustrated embodiment, the connector housing 30 is illustrated as elongate in the longitudinal direction.

The connector housing 30 defines a mating interface 42 disposed proximate to the front end 36 and a mounting interface 44 disposed proximate to the bottom end 34. The mounting interface 44 is configured to operatively engage the first substrate 24, while the mating interface 42 is configured to operatively engage the second electrical connector 26. The mating interface 42 defines a plurality of aligned receptacle pockets 45 extending through the front end 36. The pockets 45 can be arranged in a plurality of transversely extending columns 47 spaced along a longitudinal common row direction 39, and a plurality of longitudinally extending rows 51 spaced along a transverse common column direction 53. The electrical connector 22 can include as many columns 47 and rows 51 as desired.

Referring also to FIG. 1C, the first electrical connector 22 includes a plurality of electrical contacts 46 that are electrically conductive and retained by the connector housing 30. In particular, the electrical connector includes a plurality of contact modules 55 that each includes a plurality of the electrical contacts 46. Each contact module 55 includes a pair of leadframe assemblies 57 that each includes a respective leadframe housing 58, which can be a dielectric or electrically insulative material that retains respective first and second pluralities 46a and 46b of the electrical contacts 46. The electrical connector 22 can include any number of contact modules 55 as desired. The electrical contacts 46 each define a mating portion 48 disposed proximate to the mating interface 42, and an opposed mounting portion 50 disposed proximate to the mounting interface 44. In particular, the mounting portions 50 of the electrical contacts 46 extend transversely down from the bottom end 34, and the mating portions 48 extend laterally forward to a location rearward of the receptacle pockets 45. Accordingly, each mating portion 48 can be operatively aligned with a corresponding receptacle pocket 45.

The first electrical connector 20 can define a plurality ribs 52 that extend transversely out from the housing 30 can be longitudinally aligned as illustrated, and grooves 35 that are disposed between adjacent ribs 52. The connector housing 30 can include a guidance member 59 in the form of a pair of forwardly projecting protrusions 61.

Referring now to FIG. 1D, the second electrical connector 26 includes a connector housing 60 that is dielectric or electrically insulative, and defines a top end 62, an opposing bottom end 64, a front end 66, an opposing rear end 68, and opposing sides 70. The opposed sides 70 are spaced apart along the longitudinal direction L, the front end rear ends 66 and 68 are spaced apart along the lateral direction A, and the top and bottom ends 62 and 64 are spaced apart along the transverse direction T.

The connector housing 60 defines a mating interface 72 disposed proximate to the front end 66 and a mounting interface 74 disposed proximate to the rear end 68. In particular, the top and bottom ends 62 and 64 of the connector housing 60 extend forward from the rear end 68, while the front end 66 and opposing sides 70 are open so as to define a pocket 71 at the mating interface 72. The mounting interface 74 is configured to operatively engage the second substrate 28, while the mating interface 72 is configured to operatively engage the first electrical connector 22.

The second electrical connector 22 includes a second plurality of electrical contacts 76 that extend through and are supported by the rear end 68 of the connector housing 60. The electrical contacts 76 each define a mating portion 78 disposed proximate to the mating interface 72, and an opposed mounting portion 80 disposed proximate to the mounting interface 74. In particular, the mounting portions 80 of the second plurality of electrical contacts 76 extend rearward of the rear end 68 of the connector housing 60, and the mating portions 78 extend forward from the rear end 68 of the connector housing 60 and terminate in the pocket 71. The connector housing 60 includes a guidance member 63 in the form of a pair of grooves 65 sized to receive the protrusions 61 of the connector housing 30. Thus, the guidance members 59 and 63 are configured to engage so as to align the electrical connectors 22 and 26 when the connectors 22 and 26 are mated. The connector housing 60 further includes a plurality of ribs 67 that are configured to be received in the grooves 35 that are disposed between the adjacent ribs 52 of the first electrical connector 22.

As illustrated in FIG. 1E, the connector housing 60 can define a plurality of air passage slots 82 that extend through the rear end 68 proximate to the mounting portions 80 of the electrical contacts 76 so as to allow air to pass through the connector housing 60, which can reduce cross-talk between the electrical contacts during operation.

During operation, the electrical connectors 22 and 26 are configured to be mated to each other such that the mating interface 72 of the second electrical connector 26 mates with the mating interface 42 of the first electrical connector. In accordance with the illustrated embodiment, the front end 36 of the connector housing 30 is received in the pocket 41 of the connector housing 60. Referring also to FIG. 1F, and is described in more detail below, when the electrical connectors 22 and 26 are mated to each other, the mating portions 78 of the electrical contacts 76 extend through the respective receptacle pockets 45 and electrically connect to the mating portions 48 of the electrical contacts 46. Thus, each mating portion 48 can be operatively aligned with a corresponding receptacle pocket 45 such that the mating portions 78 can be inserted through the receptacle pockets 45 along a lateral insertion direction 37 and electrically connect to the mating portions 48 of the electrical contacts 46. The mounting portions 50 of the electrical contacts 46 can electrically connect to electrical traces of the first substrate 24 so as to place the electrical contacts in electrical communication with the substrate 24 and one or more electrical devices that are also connected to the substrate 24. Likewise, the mounting portions 80 of the electrical contacts 76 can electrically connect to electrical traces of the second substrate 28 so as to place the electrical contacts in electrical communication with the substrate 28 and one or more electrical devices that are also connected to the substrate 28. The mounting portions 50 and 80 are illustrated as eye-of-the-needle tails that can be press-fit into complementary apertures extending through the substrates 24 and 28, respectively. Alternatively, the mounting portions 50 and 80 can be configured to be surface mounted to the respective substrates 24 and 28. Thus, the electrical connectors 22 and 26 can be mated so as to place the substrates 24 and 28 in electrical communication.

In accordance with the illustrated embodiment, the mating portions 48 receive the mating portions 78. Thus, the electrical contacts 46 can be referred to as receptacle contacts and the electrical connector 22 can be referred to as a receptacle connector. The electrical contacts 76 can be referred to as header contacts and the electrical connector 26 can be referred to as a header connector. It should be appreciated, however that the electrical connectors 22 and 26 can be constructed in accordance with any suitable alternative embodiment without departing from the present disclosure. For instance, the first electrical connector 22 can alternatively be constructed as a header connector whose electrical contacts 46 are received by the electrical contacts 76 of the second electrical connector 26, which can alternatively be constructed as a receptacle connector.

Furthermore, in accordance with the illustrated embodiment, the mating interface 42 of the connector housing 30 is oriented substantially perpendicular with respect to the mounting interface 44, and the mating portions 48 of the electrical contacts 46 are substantially perpendicular with respect to the mounting portions 50. Thus, the electrical connector 22 can be referred to as a right-angle electrical connector, and is illustrated as a right-angle receptacle connector as described above. The mating interface 72 of the connector housing 60 is oriented substantially parallel with respect to the mounting interface 74, and the mating portions 78 of the electrical contacts 76 are substantially parallel to the mounting portions 80. Thus, the electrical connector 26 can be referred to as a vertical electrical connector, and is illustrated as a vertical header connector as described above. It should be appreciated, of course that the electrical connector 22 can alternatively be configured as a vertical electrical connector, and the electrical connector 26 can alternatively be configured as a right-angle electrical connector.

The electrical connectors 22 and 26 can be shielded or shieldless, that is the electrical connectors 22 and 26 may each include, or may be devoid of, shielding material between the adjacent electrical contacts 46, between the adjacent electrical contacts 76, or along the electrical contacts 46 and/or 76. For instance the grooves 35 disposed between adjacent ribs 52 of the first electrical connector 22 can contain an electrical contact which can be part of an electrically conductive top shield. The second electrical connector 26 can likewise contain electrically conductive pins disposed between adjacent ribs 67, such that the pins contact and thus electrically connect with the top shield of the first electrical connector 22 when the first and second electrical connectors 22 and 26 are mated. The first electrical connector 20 can define a plurality ribs 52 that extend transversely out from the housing 30 can be longitudinally aligned as illustrated, and grooves 35 that are disposed between adjacent ribs 52. The connector housing 30 can include a guidance member 59 in the form of a pair of forwardly projecting protrusions 61. The connector housing 60 further includes a plurality of ribs 67 that are configured to be received in the grooves 35 that are disposed between the adjacent ribs 52 of the electrical connector 22. Alternatively or additionally, some up to all of the electrical contacts 46, and some up to all of the electrical contacts 76, can contain or can be coated with any suitable conductive of nonconductive lossy material as desired to further reduce crosstalk between adjacent electrical contacts during operation.

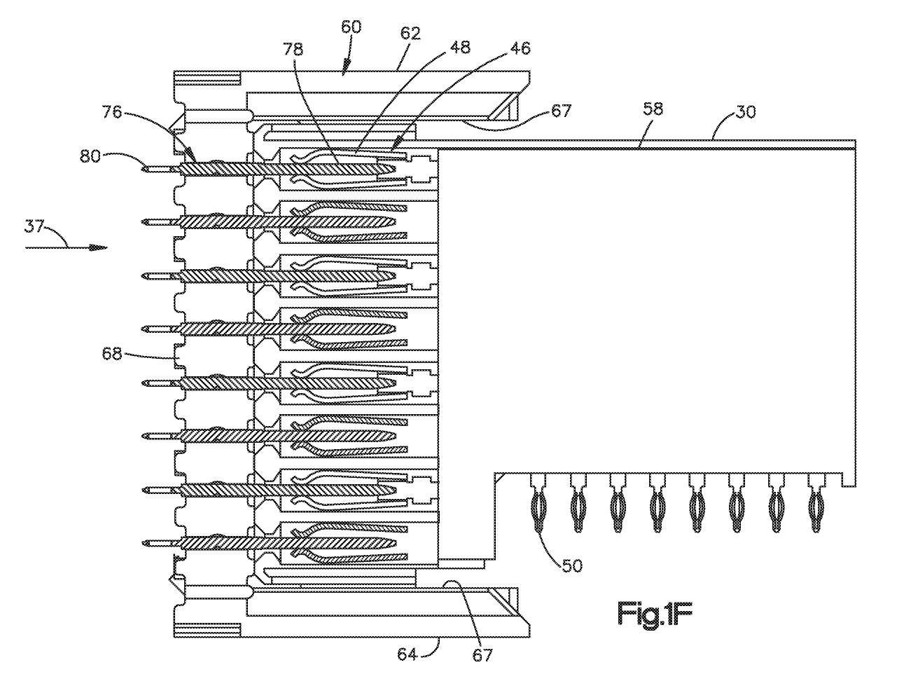

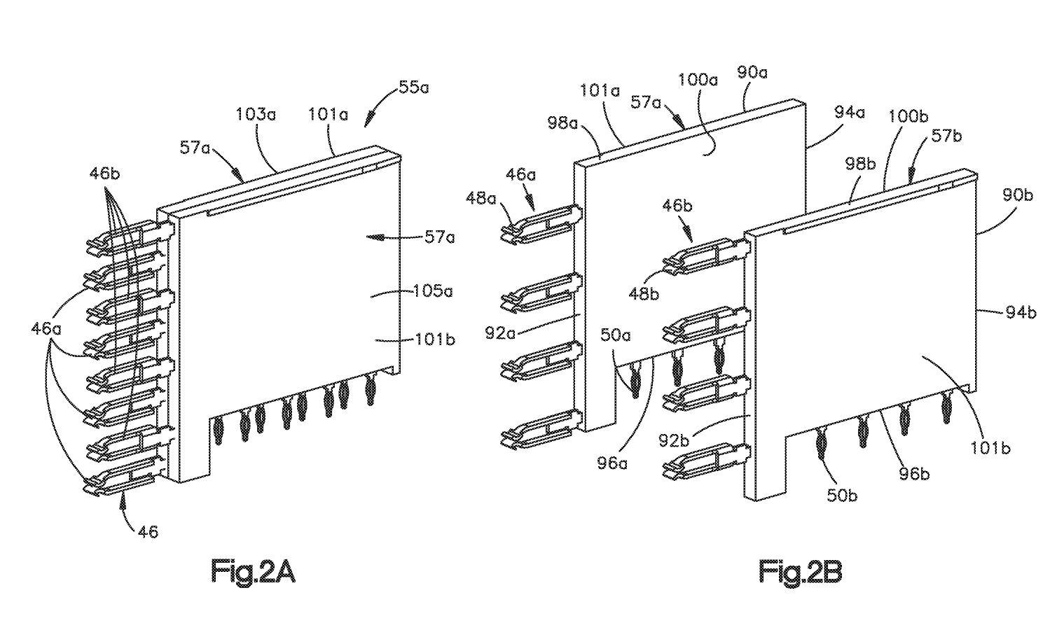

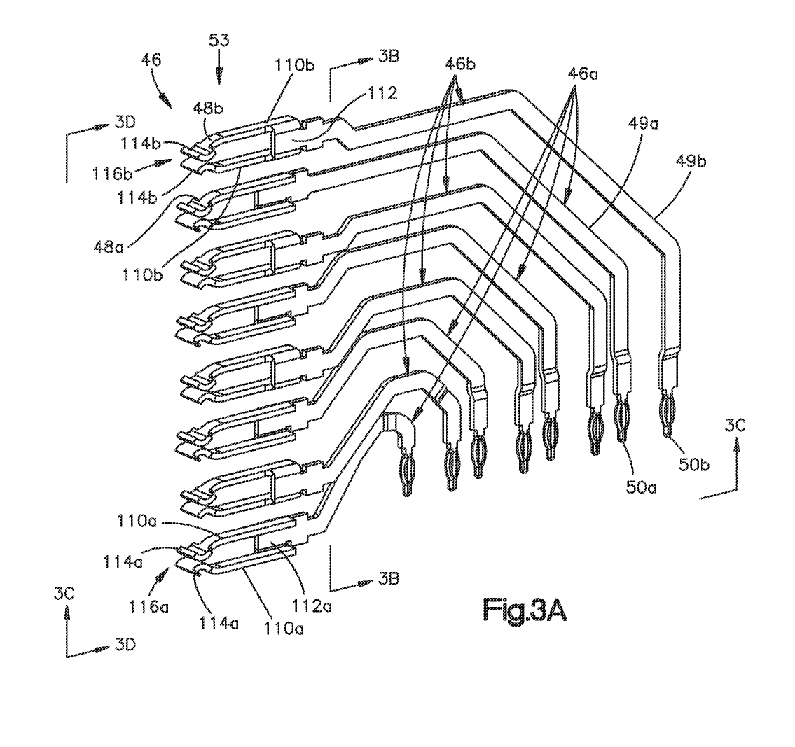

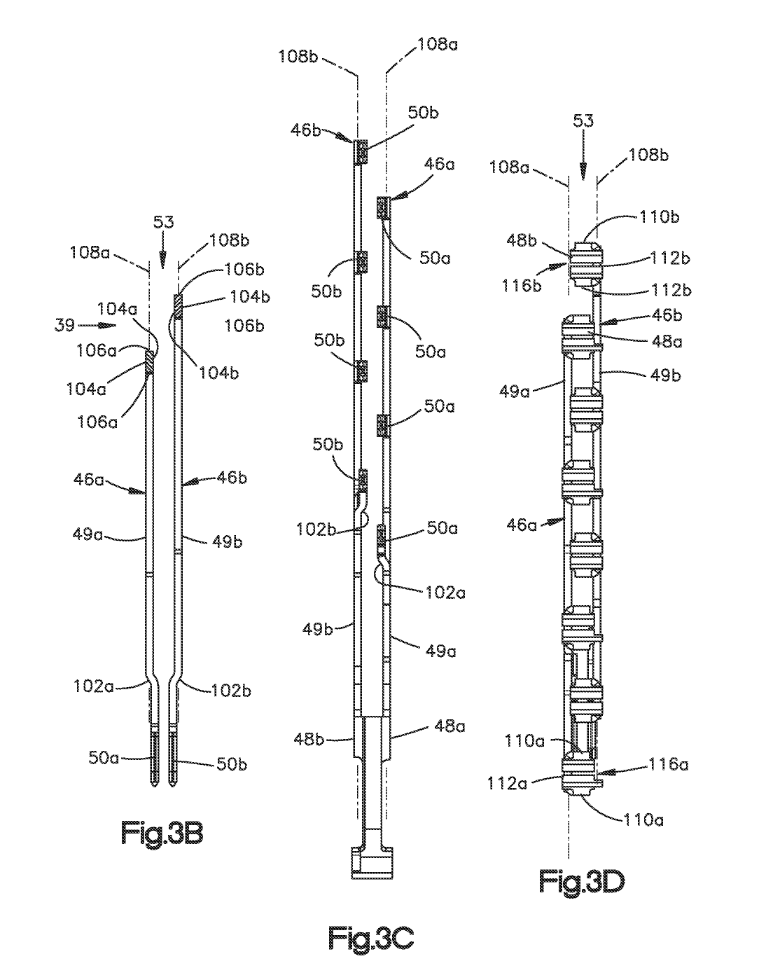

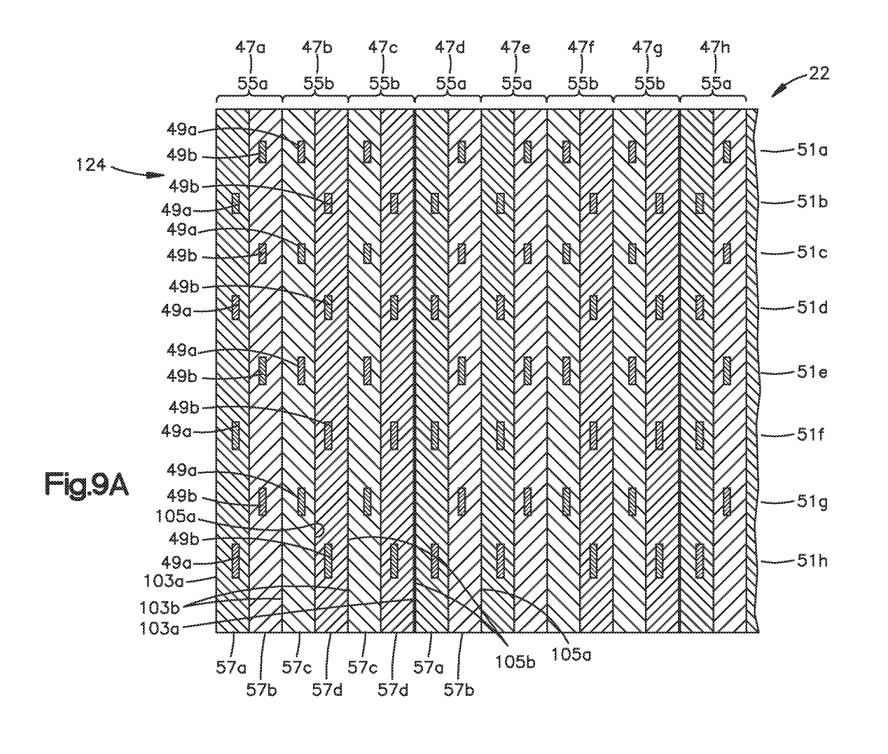

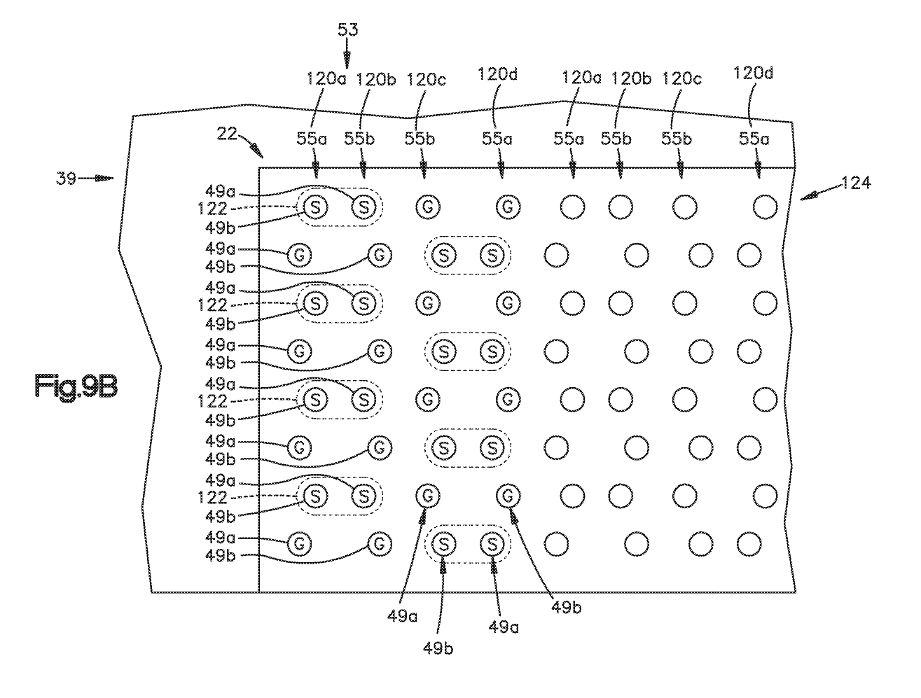

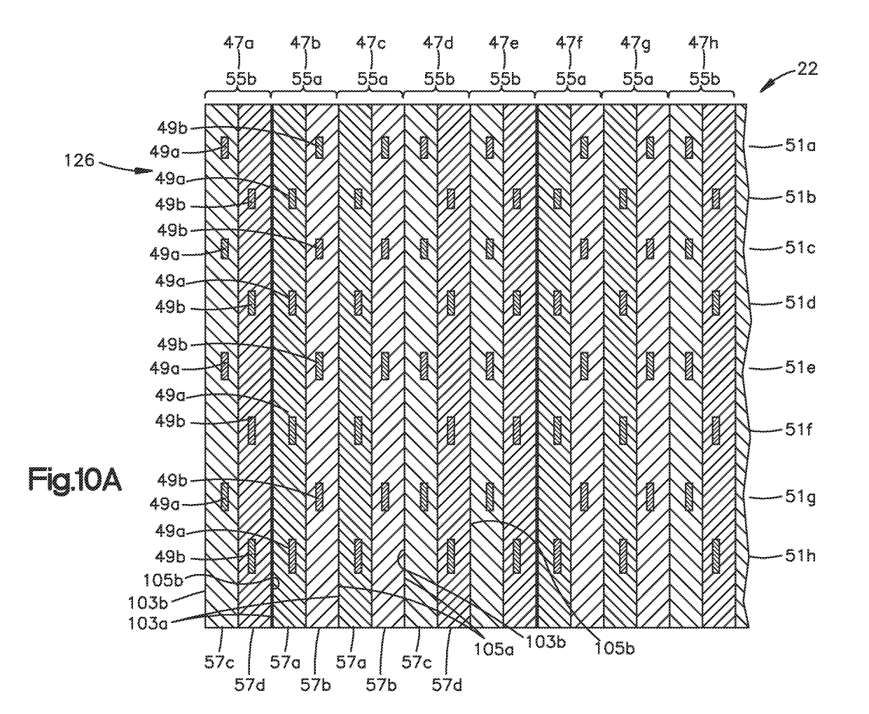

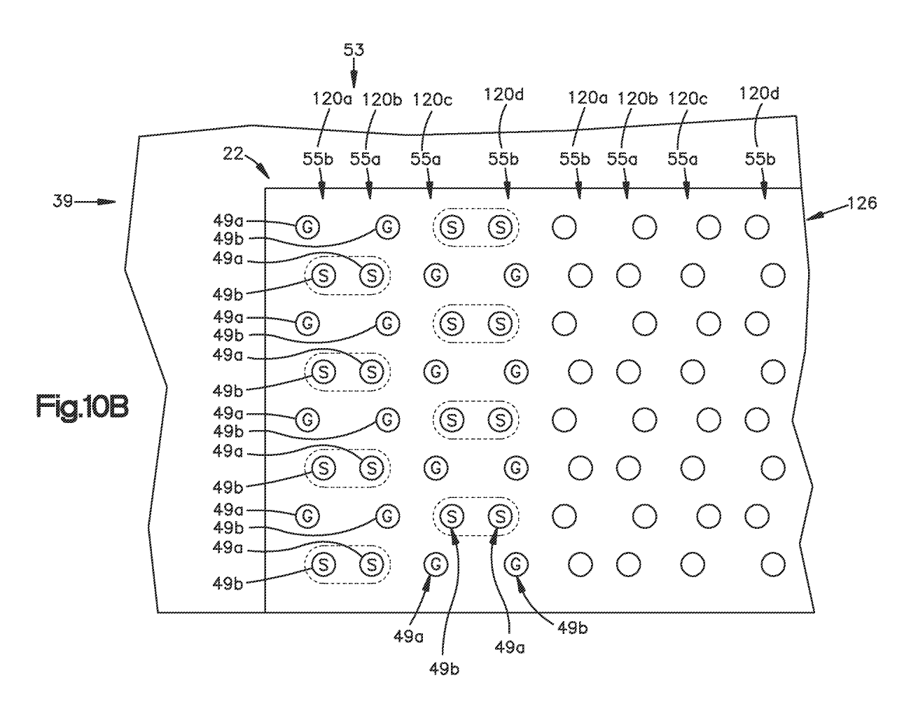

Referring now to FIGS. 2A-B, the contact modules 55 include a first contact module 55a that, in turn, includes a first leadframe assembly 57a and a second leadframe assembly 57b disposed immediately adjacent the first leadframe assembly 57a, and abutting the first leadframe assembly 57a as illustrated. The first leadframe assembly 57a includes a first leadframe housing 90a and a first plurality of electrical contacts 46a supported by the first leadframe housing 90a. The first leadframe assembly 57a can be provided as an insert molded leadframe assembly (IMLA) whereby the first leadframe housing 90a is overmolded onto the first plurality of electrical contacts 46a. The first leadframe housing 90a defines a front mating end 92a and an opposed rear end 94a that is laterally spaced from the front mating end 92a, a lower mounting end 96a and an upper end 98a that is transversely spaced from the lower mounting end 96a, and longitudinally opposed first and second inner and outer sides 100a and 101a, respectively. Each of the first plurality of electrical contacts 46a defines a mating portion 48a that extends forward from the front mating end 92a of the first leadframe housing 90a, and an opposed mounting portion 50a that extends down from the lower mounting end 96a of the first leadframe housing 90a. Referring also to FIG. 3A, each of the first plurality of electrical contacts 46a defines an intermediate portion 49a that extends between the mating portion 48a and the mounting portion 50a. At least a portion of the intermediate portion 49a is angled with respect to the mating portion 48a and mounting portion 50a. At least a portion of, for instance all of, the intermediate portion 49a of each of the first plurality of electrical contacts 46a is embedded in the first leadframe housing 96a and disposed between the first and second sides 100a and 101a. As illustrated in FIGS. 9A and 10A, the intermediate portions 49a are disposed closer to the first side 100a than the second side 101a.

Likewise, the second leadframe assembly 57b includes a second leadframe housing 90b and a second plurality of electrical contacts 46b supported by the second leadframe housing 90b. The second leadframe assembly 57b can be provided as an IMLA whereby the second leadframe housing 90b is overmolded onto the second plurality of electrical contacts 46b. The second leadframe housing 90b defines a front mating end 92b and an opposed rear end 94b that is laterally spaced from the front mating end 92b, a lower mounting end 96b and an upper end 98b that is transversely spaced from the lower mounting end 96b, and longitudinally opposed first and second inner and outer sides 100b and 101b, respectively. The inner side 100b faces the inner side 100a of the contact module 55a. Each of the first plurality of electrical contacts 46b defines a mating portion 48b that extends forward from the front mating end 92b of the second leadframe housing 90b, and an opposed mounting portion 50b that extends down from the lower mounting end 96b of the second leadframe housing 90a. Referring also to FIG. 3A, each of the second plurality of electrical contacts 46b defines an intermediate portion 49b that extends between, and as illustrated is connected between, the mating portion 48b and the mounting portion 50b. At least a portion of the intermediate portion 49b is angled with respect to the mating portion 48b and mounting portion 50b. At least a portion of, for instance all of, the intermediate portion 49b of each of the second plurality of electrical contacts 46b is embedded in the second leadframe housing 96b and disposed between the first and second sides 100b and 101b. As illustrated in FIGS. 9A and 10A, the intermediate portions 49b are disposed closer to the first side 100b than the second side 101b.

Referring also to FIG. 3A, the first electrical contacts 46a are regularly spaced along the first leadframe housing 90a in the common column direction 53. Likewise, the second electrical contacts 46b are regularly spaced along the second leadframe housing 90b in the common column direction 53. The first and second leadframe assemblies 57a and 57b are placed adjacent each other such that the respective first sides 100a and 100b face each other and the respective second sides 101a and 101b face away from each other. Thus, the respective second sides 101a and 101b of the leadframe assemblies 57a and 57b define first and second respective outer sides 103a and 105a of the first contact module 55a.

When the first and second leadframe assemblies 57a and 57b of the first contact module 55a are disposed adjacent each other, the first and second electrical contacts 46a and 46b are arranged along the common column direction 53 in an alternating pattern, such that the first electrical contacts 46a are disposed adjacent the second electrical contacts 46b along the common column direction 53, and the second electrical contacts 46b are disposed adjacent the first electrical contacts 46a along the common column direction 53. In particular, along the common column direction 53, the uppermost second electrical contact 46b defines the uppermost electrical contact 46 of the first contact module 55a, while the lowermost first electrical contact 46a defines the lowermost electrical contact 46 of the first contact module 55a. Each of the first plurality of electrical contacts 46a that are disposed transversely between adjacent ones of the second plurality of electrical contacts 46b are disposed midway between the adjacent ones of the second plurality of electrical contacts 46b. Likewise, each of the second plurality of electrical contacts 46b that are disposed transversely between adjacent ones of the first plurality of electrical contacts 46a are disposed midway between the adjacent ones of the first plurality of electrical contacts 46a.

Referring now also to FIGS. 3B-C, the mounting portions 50a of at least one or more up to all of the first plurality of electrical contacts 46a can be offset with respect to the respective intermediate portions 49a. Thus, the first plurality of electrical contacts 46a can be configured as offset electrical contacts. In particular, each of the first plurality of electrical contacts 46a includes a jogged interface 102a that joins the intermediate portion 49a and the mounting portion 50a so as to cause the mounting portion 50a to be offset with respect to the intermediate portion 49a in a direction toward the first side 100a of the first leadframe housing 90a. The mounting portion 50a extends in a direction parallel to the intermediate portion 49a. The intermediate portion 49a is illustrated as including a pair of opposing outer surfaces that define respective broadsides 104a that extend along the common column direction 53, and a pair of opposing outer surfaces that define edges 106a that are connected between the broadsides 104a along the common row direction 39. The broadsides 104a are thus also connected between the edges 106a. The broadsides 104a define a length between the opposing edges 106a, and the edges 106a define a length between the opposing broadsides 104a, such that the length of the broadsides 104a is greater than the length of the edges 106a. In this regard, it should be appreciated that the broadsides 104a face the first and second sides 100a and 101a of the first leadframe housing 90a.

Likewise, the mounting portions 50b of at least one or more up to all of the second electrical contacts 46b can be offset with respect to the respective intermediate portions 49b. In particular, each of the second plurality of electrical contacts 46b includes a jogged interface 102b that joins the intermediate portion 49b and the mounting portion 50b so as to causes the mounting portion 50b to be offset with respect to the intermediate portion 49b in a direction toward the first side 100b of the second leadframe housing 90b. The mounting portion 50b extends in a direction parallel to the intermediate portion 49b. The intermediate portion 49b is illustrated as including a pair of opposing outer surfaces that define respective broadsides 104b that extend along the common column direction 53, and a pair of opposing outer surfaces that define edges 106b that are connected between the broadsides 104 along the common row direction 39. The broadsides 104b are thus also connected between the edges 106b. The broadsides 104b define a length between the opposing edges 106b, and the edges 106b define a length between the opposing broadsides 104b, such that the length of the broadsides 104b is greater than the length of the edges 106b. In this regard, it should be appreciated that the broadsides 104b face the first and second sides 100b and 101b of the second leadframe housing 90b.

It should be further appreciated that the mounting portions 50a are offset with respect to their intermediate portions 49a in a direction toward the second plurality of electrical contacts 46b, and the mounting portions 50b are offset with respect to their intermediate portions 49b in a direction toward the first plurality of electrical contacts 46a. Otherwise stated, the mounting portions 50a of the first plurality of electrical contacts 46a and the mounting portions 50b of the second plurality of electrical contacts 46b of the first contact module 55a are offset toward each other, and offset from each other.

With continuing reference to FIGS. 2A-3C, the intermediate portions 49a of the first plurality of electrical contacts 46a are coplanar and are aligned or disposed on a first common plane 108a that extends vertically or in the transverse direction. Likewise, the intermediate portions 49b of the first plurality of electrical contacts 46b are coplanar and are aligned or disposed on a second common plane 108b that extends vertically or in the transverse direction. The first and second common planes 108a and 108b are thus parallel to each other, and extend along the common column direction 53. Thus, the first and second common planes 108a and 108b extend parallel to each other, and spaced from each other along the common row direction 39 when the first and second leadframe assemblies 57a-b are placed adjacent each other to form the first contact module 55a. The mounting portions 50a are offset with respect to the respective first common plane 108a in a direction toward the second common plane 108b, and the mounting portions 50b are offset with respect to the respective second common plane 108b in a direction toward the first common plane 108a.

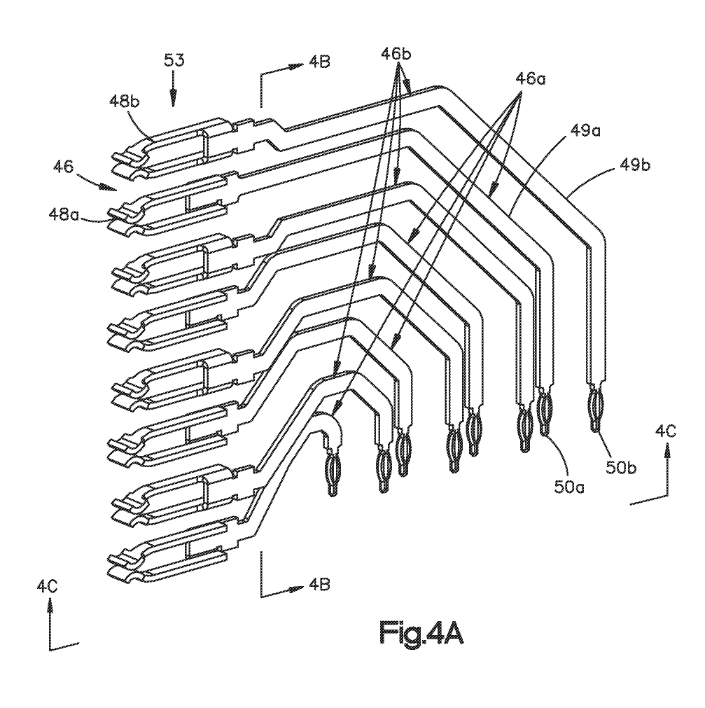

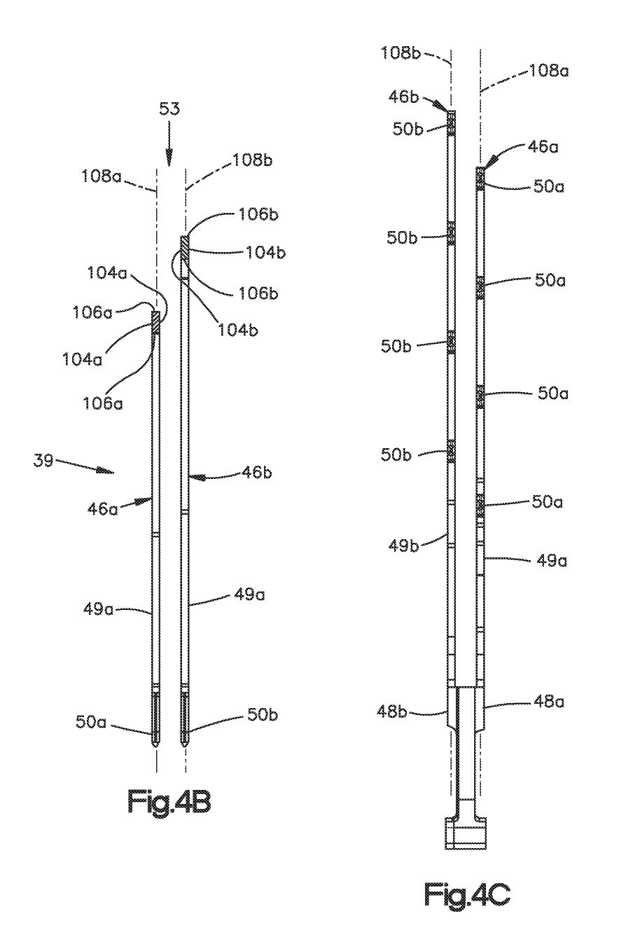

Alternatively, referring now to FIGS. 4A-C, the first plurality of electrical contacts 46a can be planar such that the intermediate portion 49a and the mounting portion 50a of one or more, up to all, of the first plurality of electrical contacts 46a are disposed on the first common plane 108a. Otherwise stated, the first electrical contacts 46a can be devoid of the jogged interface 102a, such that the intermediate portion 49a and the mounting portion 50a of one or more up to all of the first plurality of electrical contacts 46a are coplanar. It should thus be appreciated that one or more up to all of the first plurality of electrical contacts 46a of the first leadframe assembly 57a can include the jogged interface 102a, and that one or more up to all of the first plurality of electrical contacts 46a of the first leadframe assembly 57a can be devoid of the jogged interface 102a.

Likewise, the second plurality of electrical contacts 46b can be planar such that the intermediate portion 49b and the mounting portion 50b of one or more, up to all, of the second plurality of electrical contacts 46b are disposed on the first common plane 108b. Otherwise stated, the second electrical contacts 46b can be devoid of the jogged interface 102b, such that the intermediate portion 49b and the mounting portion 50b of one or more up to all of the second plurality of electrical contacts 46b are coplanar. It should thus be appreciated that one or more up to all of the second plurality of electrical contacts 46b of the second leadframe assembly 57b can include the jogged interface 102b, and that one or more up to all of the second plurality of electrical contacts 46b of the second leadframe assembly 57b can be devoid of the jogged interface 102b.

Referring now to FIGS. 3A and 3D, the mating portions 48a of the first plurality of electrical contacts extend from a location aligned with the respective intermediate portions 49a, and thus also aligned with the first common plane 108a, in a longitudinal direction substantially perpendicular to the insertion direction 37 (see FIG. 1F) and toward the first side 100a of the first leadframe housing 90a. Otherwise stated, the mating portions 48a extend toward the second leadframe assembly 57b and thus the second plurality of electrical contacts 46b of the second leadframe assembly 57b. In particular, the first mating portion 48a, is generally c-shaped, and includes transversely opposed arms 110a that extend laterally forward from the intermediate portions 49a. The first mating portion 48a further includes a leg 112a that is connected between the arms 110a such that the arms 110a extend from the leg 112a toward the first side 100a of the first leadframe housing 90a. The leg 112a can be disposed in the common plane 108a, and thus aligned with the intermediate portion 49a.

The first mating portions 48a can further include first and second contact beams 114a that extend forward from the arms 110a, and are transversely opposed so as to define a receptacle 116a therebetween that is configured to receive the mating portions 78 of the corresponding second plurality of electrical contacts 76. The front ends of the contact beams 114a can flare toward each other so as to provide a retention spring force against the mating portions 78 when the mating portions 78 are received in the receptacles 116a. As illustrated in FIG. 8, the receptacle pockets 45 of the connector housing 30 are aligned with the mating portions 48a of the first plurality of electrical contacts 46a. For instance, the receptacles 116a defined by the first and second contact beams 114a are operatively aligned with the receptacle pockets 45 such that the mating portions 78 can be inserted through the receptacle pockets 45 along the insertion direction 37 and into the receptacles 116a such that both contact beams 114a contact the received mating portion 78, thereby establishing an electrical connection between the electrical contacts 80 and the first plurality of electrical contacts 46a. Otherwise stated, a plurality of the receptacle pockets 45 is aligned with a select one of the mating portions 48a of the first plurality of electrical contacts 46a.

Likewise, with continuing reference to FIGS. 3A and 3D, the mating portions 48b of the second plurality of electrical contacts 46b extend from a location aligned with the respective intermediate portions 49b, and thus also aligned with the second common plane 108b, in a longitudinal direction substantially perpendicular to the insertion direction 37 (see FIG. 1F) and toward the first side 100b of the second leadframe housing 90b. Otherwise stated, the mating portions 48b extend toward the first leadframe assembly 57a and thus the first plurality of electrical contacts 46a of the first leadframe assembly 57a. In particular, the second mating portion 48b is generally c-shaped, and includes transversely opposed arms 110b that extend laterally forward from the intermediate portions 49b. The second mating portion 48b further includes a leg 112b that is connected between the arms 110b such that the arms 110b extend from the leg 112b toward the first side 100b of the first leadframe housing 90b. The leg 112b can be disposed in the common plane 108b, and thus aligned with the intermediate portion 49b.

The second mating portions 48b can further include first and second contact beams 114b that extend forward from the arms 110b, and are transversely opposed so as to define a receptacle 116b therebetween that is configured to receive the mating portions 78 of the corresponding second plurality of electrical contacts 76. The front ends of the contact beams 114b can flare toward each other so as to provide a retention spring force against the mating portions 78 when the mating portions 78 are received in the receptacles 116b. As illustrated in FIG. 8, the receptacle pockets 45 of the connector housing 30 are aligned with the mating portions 48b of the first plurality of second plurality of electrical contacts 46b. For instance, the receptacles 116b defined by the first and second contact beams 114b are operatively aligned with the receptacle pockets 45 such that the mating portions 78 can be inserted through the receptacle pockets 45 along the insertion direction 37 and into the receptacles 116b such that both contact beams 114b contact the received mating portion 78, thereby establishing an electrical connection between the electrical contacts 80 and the second plurality of electrical contacts 46b. Otherwise stated, a plurality of the receptacle pockets 45 is aligned with a select one of the mating portions 48b of the second plurality of electrical contacts 46b. Thus, each of the receptacle pockets 45 is aligned with a select one of the mating portions 48a of the first plurality of electrical contacts 46a and the mating portions 48b of the second plurality of electrical contacts 46b. Furthermore, the receptacles 116a and 116b are at least partially aligned with each other with respect to the common column direction 53.

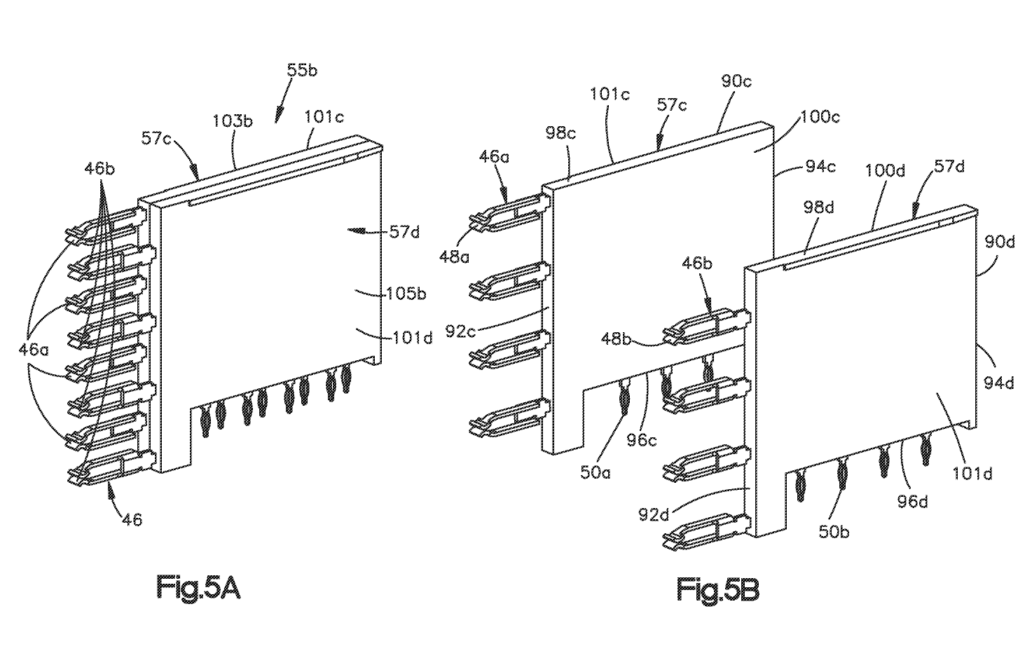

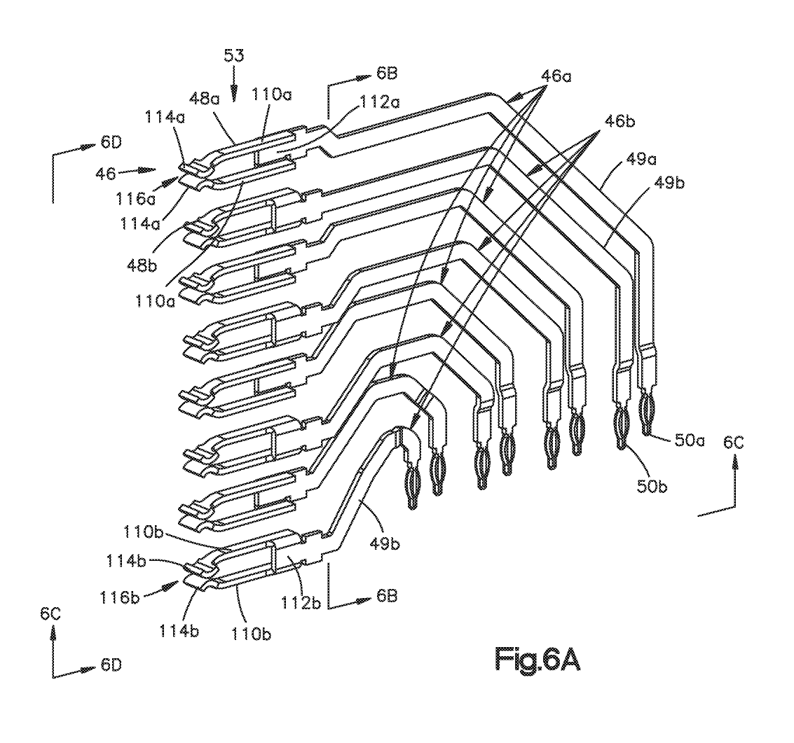

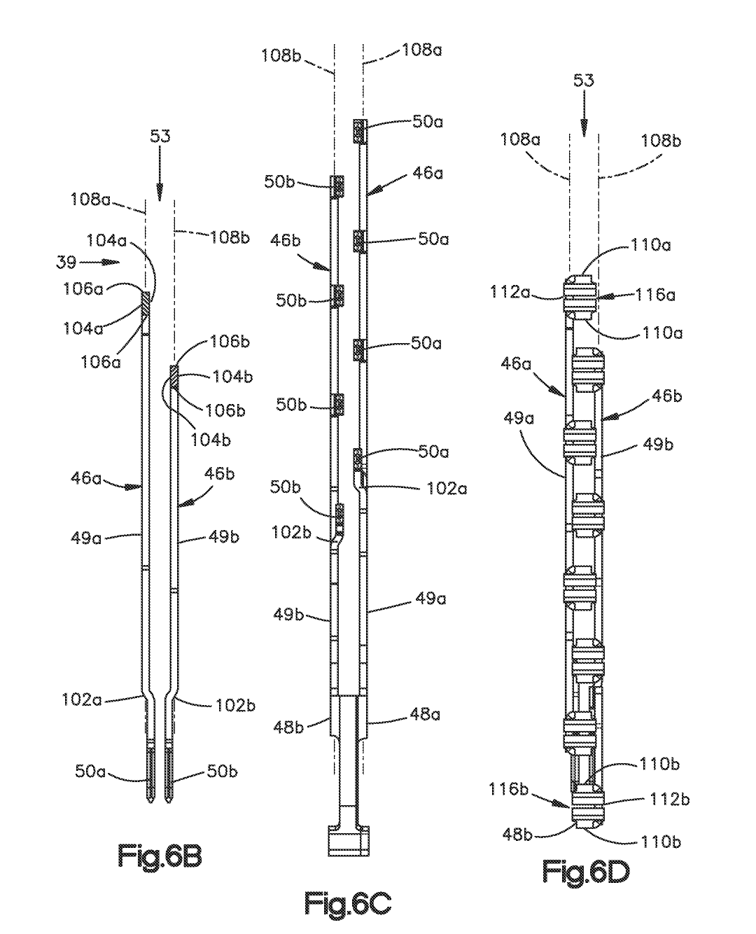

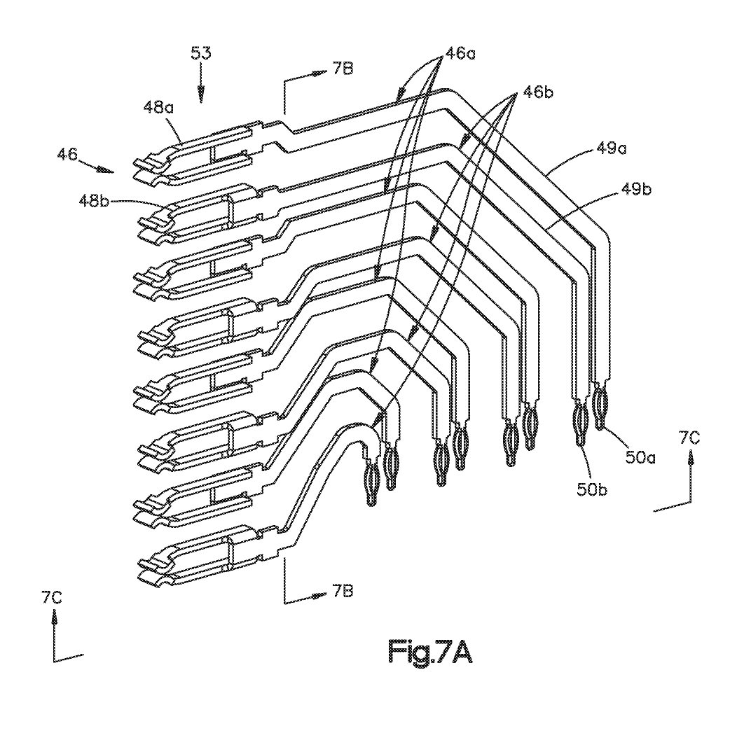

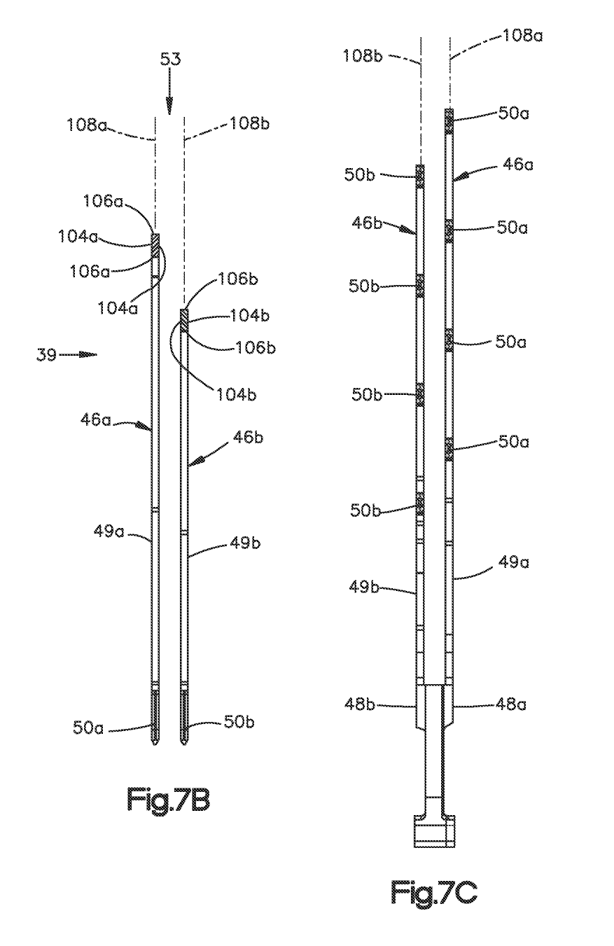

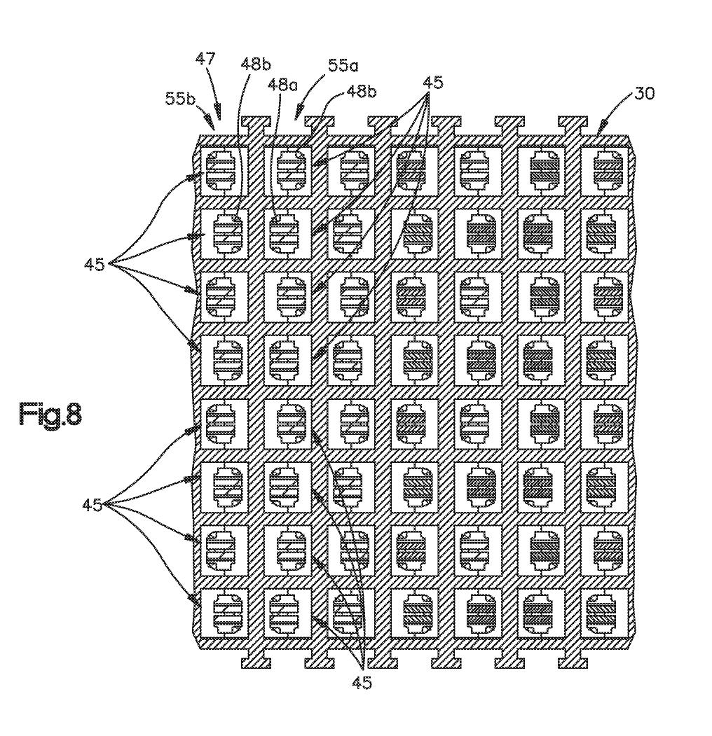

Referring now to FIGS. 5A-7C, the contact modules 55 include a second contact module 55b that, in turn, includes a third leadframe assembly 57c and a fourth leadframe assembly 57d disposed immediately adjacent the third leadframe assembly 57c, and abutting the third leadframe assembly 57c as illustrated. The third leadframe assembly 57c includes a third leadframe housing 90c and the first plurality of electrical contacts 46a supported by the third leadframe housing 90c. The first plurality of electrical contacts 46a of the third leadframe assembly 57c are constructed as described above with respect to the first plurality of electrical contacts 46a of the first leadframe assembly 57a. For instance, the first plurality of electrical contacts 46a of the second contact module 55b can include the jogged interface 102a as illustrated in FIGS. 6A-D, or can be planar and devoid of the jogged interface 102a as illustrated in FIGS. 7A-C. However, the first plurality of electrical contacts 46a are placed differently in the third leadframe housing 90c, for instance at different locations in third leadframe housing 90c, with respect to the placement of the first plurality of electrical contacts 46a in the first leadframe housing 90a, as is described in more detail below.

The fourth leadframe assembly 57d includes a fourth leadframe housing 90d and the second plurality of electrical contacts 46b supported by the fourth leadframe housing 90d. The second plurality of electrical contacts 46b of the fourth leadframe assembly 57d are constructed as described above with respect to the second plurality of electrical contacts 46b of the second leadframe assembly 57b. For instance, the second plurality of electrical contacts 46b of the second contact module 55b can include the jogged interface 102b as illustrated in FIGS. 6A-D, or can be planar and devoid of the jogged interface 102b as illustrated in FIGS. 7A-C. However, the second plurality of electrical contacts 46b are placed differently in the fourth leadframe housing 90d, for instance at different locations in fourth leadframe housing 90d, with respect to the placement of the second plurality of electrical contacts 46b in the second leadframe housing 90b, as is described in more detail below.

The third leadframe assembly 57c can be provided as an insert molded leadframe assembly (IMLA) whereby the third leadframe housing 90c is overmolded onto the first plurality of electrical contacts 46a. The third leadframe housing 90c defines a front mating end 92c and an opposed rear end 94c that is laterally spaced from the front mating end 92c, a lower mounting end 96c and an upper end 98c that is transversely spaced from the lower mounting end 96c, and longitudinally opposed first and second inner and outer sides 100c and 101c, respectively. The mating portion 48a of each of the first plurality of electrical contacts 46a extends forward from the front mating end 92c of the third leadframe housing 90c, and the mounting portion 50a of each of the first plurality of electrical contacts 46a extends down from the lower mounting end 96c. At least a portion of, for instance all of, the intermediate portion 49a of each of the first plurality of electrical contacts 46a is embedded in the third leadframe housing 96c and disposed between the first and second sides 100c and 101c. As illustrated in FIGS. 9A and 10A, the intermediate portions 49a are disposed closer to the first side 100c than the second side 101c.

Likewise, the fourth leadframe assembly 57d can be provided as an insert molded leadframe assembly (IMLA) whereby the fourth leadframe housing 90d is overmolded onto the second plurality of electrical contacts 46b. The fourth leadframe housing 90d defines a front mating end 92d and an opposed rear end 94d that is laterally spaced from the front mating end 92d, a lower mounting end 96d and an upper end 98d that is transversely spaced from the lower mounting end 96d, and longitudinally opposed first and second inner and outer sides 100d and 101d, respectively. The inner side 100d faces the inner side 100c of the second contact module 55b. The mating portion 48b of each of the second plurality of electrical contacts 46b extends forward from the front mating end 92d of the fourth leadframe housing 90d, and the mounting portion 50b of each of the second plurality of electrical contacts 46b extends down from the lower mounting end 96d. At least a portion of, for instance all of, the intermediate portion 49b of each of the second plurality of electrical contacts 46b is embedded in the fourth leadframe housing 96d and disposed between the first and second sides 100d and 101d. As illustrated in FIGS. 9A and 10A, the intermediate portions 49b are disposed closer to the first side 100d than the second side 101d.

Thus, the first leadframe housing 90a, the second leadframe housing 90b, the third leadframe housing 90c, and the fourth leadframe housing 90d are all constructed substantially identical to each other.

Referring also to FIG. 6A, the first electrical contacts 46a are regularly spaced along the third leadframe housing 90c in the common column direction 53. Likewise, the second electrical contacts 46b are regularly spaced along the fourth leadframe housing 90d in the common column direction 53. The third and fourth leadframe assemblies 57c and 57d are placed adjacent each other such that the respective first sides 100c and 100d face each other and the respective second sides 101c and 101d face away from each other. Thus, the respective second sides 101c and 101c of the leadframe assemblies 57c and 57d define first and second respective outer sides 103b and 105b of the second contact module 55a.

As described above, the first plurality of electrical contacts 46a are positioned differently in the third leadframe housing 90c than in the first leadframe housing 90a, and the second plurality of electrical contacts 46b are positioned differently in the fourth leadframe housing 90d than in the second leadframe housing 90b. In particular, when the third and fourth leadframe assemblies 57c and 57d of the second contact module 55b are disposed adjacent each other, the first and second electrical contacts 46a and 46b are arranged along the common column direction 53 in an alternating pattern, such that the first electrical contacts 46a are disposed adjacent the second electrical contacts 46b along the common column direction 53, and the second electrical contacts 46b are disposed adjacent the first electrical contacts 46a along the common column direction 53. In particular, along the common column direction 53, the uppermost one of the first plurality of electrical contacts 46a defines the uppermost electrical contact 46 of the second contact module 55b (as opposed to the uppermost one of the second plurality of electrical contacts 46b of the first contact module 55a), while the lowermost one of the second plurality of electrical contacts 46b defines the lowermost electrical contact 46 of the second contact module 55b (as opposed to the lowermost one of the first plurality of electrical contacts 46a of the first contact module 55a). Thus, the position of the first and second pluralities of electrical contacts 46a and 46b relative to each other along the common column direction 53 differ in the first and contact modules 55a and 55b, respectively.

Referring now to FIGS. 9A and 10A, the first electrical connector 22 is illustrated having eight consecutive columns 47a-h, and eight consecutive rows 51a-h, though as described above the electrical connector 22 can include any number of columns 47 and rows 51 as desired. In accordance with the illustrated embodiment, the row 51a is the uppermost row and the row 51h is the lowermost row. The number of columns 47 can be the same or different than the number of rows 51. The intermediate portions 49a of the first plurality of electrical contacts 46a of the first contact module 55a are disposed in rows 51b, 51d, 51f, and 51h, and the intermediate portions 49b of the second plurality of electrical contacts 46b of the first contact module 55a are disposed in rows 51a, 51c, 51e, and 51g. The intermediate portions 49a of the first plurality of electrical contacts 46a of the second contact module 55b are disposed in rows 51a, 51c. 51e, and 51g, and the intermediate portions 49b of the second plurality of electrical contacts 46 of the second contact module 55b are disposed in rows 51b, 51d, 51f, and 51h.

Referring now to FIGS. 9A-B in particular, the electrical connector 22 is arranged in a first contact configuration 124 of immediately adjacent contact modules in a repeating 55a-55b-55b-55a configuration, such that no contact modules are disposed between the immediately adjacent contact modules. As illustrated, the first contact module 55a is disposed in columns 47a, 47d, 47e, and 47h, and the second contact module 55b is disposed in columns 47b, 47c, 47f, and 47g. Thus, in accordance with the embodiment illustrated in FIGS. 9A-B, the electrical connector includes a first contact module 120a provided as the first contact module 55a, a second contact module 120b provided as the second contact module 55b, a third contact module 120c provided as the second contact module 55b, and a fourth contact module 120d provided as the first contact module 55a.

Referring now to FIGS. 2A-B, 5A-B, and 9A-B, in the first contact configuration 124, the first and contact modules 120a and 120b are provided such that the second side 105a of the first contact module 55a (see FIG. 2A) is disposed adjacent the first side 103b of the second contact module 55b (see FIG. 5A). Thus, the second outer side 101b of the second leadframe assembly 57b is disposed adjacent the second outer side 101c of the third leadframe assembly 57c. Each of the second plurality of electrical contacts 49b of the first contact module 55a is disposed in the same row as each of the first plurality of electrical contacts 49a of the second contact module 55b. Likewise, each of the first plurality of electrical contacts 49a of the first contact module 55a is disposed in the same row as each of the second plurality of electrical contacts 49b of the second contact module 55b.

The intermediate portions 49a of the first plurality of electrical contacts 46a of the first contact module 55a are disposed closer to the first side 103a than the second side 105a. The intermediate portions 49b of the second plurality of electrical contacts 46b of the first contact module 55a are disposed closer to the second side 105a than the first side 103a. The intermediate portions 49a of the second contact module 55b are disposed closer to the first side 103b than the second side 105b. The intermediate portions 49b of the second contact module 55b are disposed closer to the second side 105b than the first side 103b.

Accordingly, when the first and second contact modules 55a and 55b are disposed adjacent each other such that the second side 105a faces the first side 103b as illustrated in FIG. 9B with respect to the first and second contact modules 120a and 120b, the intermediate portions 49b and 49a of the first and second contact modules 120a and 120b, respectively, are spaced more closely than the intermediate portions 49a and 49b of the first and second contact modules 120a and 120b, respectively. The adjacent first and second pluralities of electrical contacts 46a and 46b of the first and second contact modules 120a and 120b along the common row direction 39, respectively, define ground contacts G. The adjacent second and first pluralities of electrical contacts 46b and 46a of the first and second contact modules 120a and 120b along the common row direction 39, respectively define signal contacts S. The adjacent signal contacts S along the common row direction 39 define differential signal pairs 122. Thus, it should be appreciated that the intermediate portions 49b and 49a of each differential pair 122 of adjacent signal contacts 46b and 46a of the first and second contact modules 120a and 120b, respectively, are spaced more closely than the intermediate portions 49a and 49b of each pair of adjacent ground contacts 46a and 46b of the first and second contact modules 120 and 120b, respectively. Alternatively, the signal contacts S could be provided as single-ended signal contacts.

None of the signal contacts S of the differential signal pairs 122 in the first contact configuration 124 is disposed immediately adjacent another signal contact. Rather, a ground contact G is disposed immediately adjacent the signal contacts S of each differential pair 122. For instance, a ground contact G can be disposed on both sides of the differential pair 122 in the respective row, and a ground contact G can be disposed on both sides of each signal contact C of the differential pair 122 in their respective columns 57. Thus, it can be said that the signal contacts S of a given differential pair 122 are surrounded by ground contacts G, thereby providing reduced crosstalk during operation. Furthermore, because the intermediate portions of adjacent signal contacts S that define a given differential signal pairs 122 are offset closer together than the adjacent ground contacts, the pluralities of differential signal pairs 122 are also spaced further apart from each other, thereby reducing cross-talk during operation. The first electrical connector 122 can provide improve electromagnetic field coupling between the signal contacts S that define a differential signal pair 122, such that the first electrical connector 22 can be devoid of shields and operate at 10 Gigabits/second with 6% or less of asynchronous, worst-case, multi-active cross-talk.

Furthermore, when the second and first contact modules 55b and 55a are disposed adjacent each other such that the second side 105b faces the first side 103a as illustrated in FIG. 9B with respect to the third and fourth contact modules 120c and 120d, the intermediate portions 49b and 49a of the third and fourth contact modules 120c and 120c, respectively, are spaced more closely than the intermediate portions 49a and 49b of the third and fourth contact modules 120c and 120d, respectively. The adjacent first and second pluralities of electrical contacts 46a and 46b of the third and fourth contact modules 120a and 120b along the common row direction 39, respectively, define ground contacts G. The adjacent second and first pluralities of electrical contacts 46b and 46a of the third and fourth contact modules 120a and 120b along the common row direction 39, respectively define signal contacts S. The adjacent signal contacts S along the common row direction 39 define differential signal pairs 122. Thus, it should be appreciated that the intermediate portions 49b and 49a of each differential pair 122 of adjacent signal contacts 46b and 46a of the third contact modules 120a and 120b, respectively, are spaced more closely than the intermediate portions 49a and 49b of each pair of adjacent ground contacts 46a and 46b of the third and fourth contact modules 120 and 120b, respectively.

It should be appreciated that each of the four contact modules 120a-120d has a different contact configuration than each of the other of the four contact modules 120a-and 120d. The different contact configuration can be at least one of 1) a different assignment the signal and ground contacts with respect to a common column direction along the respective columns of each contact module, and 2) a placement of the electrical contacts in the contact modules.

For instance, the first contact module 120a is illustrated as the first contact module 55a, while the second and third contact modules 120b and 120c are each illustrated as the second contact module 55b. Thus, the row location of the first plurality of electrical contacts 46a of the first contact module 120a is different than the row location of the first plurality of electrical contacts 46a of the second and third contact modules 120b and 120c along their respective columns in the common column direction 53. Likewise, the row location of the second plurality of electrical contacts 46b of the first contact module 120a is different than the location of the second plurality of electrical contacts 46b of the second and third contact modules 120b and 120c along their respective columns in the common column direction 53.

Additionally, the first contact module 120a has a different assignment of the signal and ground contacts with respect to the column direction 53 along the column 47a than the fourth contact module 120d along the column 47d. In particular, while the first and fourth contact modules 120a and 120d are both illustrated as first contact modules 55a (and thus have the same placement of electrical contacts in the respective contact modules along the column direction), the first plurality of electrical contacts 46a of the first contact module 120a are ground contacts G, while the first plurality of electrical contacts 46a of the fourth contact module 120d are signal contacts S. Likewise, each of the second plurality of electrical contacts 46b of the first contact module 120a is a signal contact S, while each of the second plurality of electrical contacts 46b of the fourth contact module 120d are is a ground contact G.

Because the signal contacts S of each differential signal pair 122 are disposed in different columns 53 and are disposed adjacent each other along the common row direction 39, the broadsides 104 of the signal contacts S face each other (see FIGS. 3B and 6B). Thus, it can be said that each of the differential signal pairs 122 is a broadside coupled differential signal pair.

It is further appreciated that the first contact configuration 124 provides a first contact module 120a, a second contact module 120b disposed immediately adjacent the first contact module 120a along the common row direction 39, and a third contact module 120c disposed immediately adjacent the second contact module 120b along the row direction 39 such that the second contact module 120b is disposed between the first and the third contact modules 120a and 120c, respectively. Each of the first, second, and third contact modules 120a-c, respectively include a plurality of electrical contacts 46 spaced along respective columns 47a-c. At least one of the electrical contacts 46 of each of the contact modules 120a-c is a signal contact S, and at least one of the electrical contacts 46 of each of the contact modules 120a-c is a signal contact G. The electrical contacts 46a and 46b of the first contact module 120a are arranged in a first pattern along the common column direction 53, as described above with respect to the contact module 55a. The electrical contacts 46a and 46b of the second contact module 120b are arranged in a second pattern that is different than the first pattern along the column direction, and the electrical contacts of the third contact module 120c are arranged in a second pattern. The first contact configuration 124 further includes a fourth contact module 120d disposed immediately adjacent the third contact module 120c such that the third contact module 120c is disposed between the second contact module 120b and the fourth contact module 120d. The fourth contact module 120d including a plurality of electrical contacts 46 spaced along the column 47d. At least one of the electrical contacts 46 of the fourth contact module 120d is a signal contact S, and at least one of the electrical contacts 46 of the fourth contact module 120d is a ground contact G. The electrical contacts 46 of the fourth contact module 120 are arranged in the first pattern along the column direction 53.

Referring now to FIGS. 10A-B in particular, the electrical connector 22 is arranged in a second contact configuration 126 of immediately adjacent contact modules in a repeating 55b-55a-55a-55b configuration, such that no contact modules are disposed between the immediately adjacent contact modules. Thus, it should be appreciated that the second contact configuration 126 is different than the first contact configuration 124. In particular, the second contact configuration 126 is the inverse of the first contact configuration 124, whereby the first contact modules 55a of the first contact configuration 124 are replaced by second contact modules 55b in the second contact configuration 126, and the second contact modules 55b of the first contact configuration 124 are replaced by the first contact modules 55a in the second contact configuration 126. As illustrated, the second contact module 55b is disposed in columns 47a, 47d, 47e, and 47h, and the first contact module 55a is disposed in columns 47b, 47c, 47f, and 47g. Thus, in accordance with the embodiment illustrated in FIGS. 10A-B, the electrical connector includes a first contact module 120a provided as the second contact module 55b, a second contact module 120b provided as the first contact module 55a, a third contact module 120c provided as the first contact module 55a, and a fourth contact module 120d provided as the second contact module 55b.

Referring now to FIGS. 2A-B, 5A-B, and 10A-B, in the second contact configuration 126, the first and contact modules 120a and 120b are provided such that the second side 105b of the second contact module 55b (see FIG. 5A) is disposed adjacent the first side 103a of the first contact module 55a (see FIG. 2A). Thus, the outer side 101d of the fourth leadframe assembly 57b is disposed adjacent the outer side 101a of the first leadframe assembly 57a. Each of the first plurality of electrical contacts 49a of the second contact module 55b is disposed in the same row as each of the second plurality of electrical contacts 49b of the first contact module 55a. Likewise, each of the second plurality of electrical contacts 49b of the second contact module 55b is disposed in the same row as each of the first plurality of electrical contacts 49a of the second contact module 55a.

The intermediate portions 49b of the second plurality of electrical contacts 46b of the second contact module 55b are disposed closer to the second side 105b than the first side 103b. The intermediate portions 49a of the first plurality of electrical contacts 46a of the first contact module 55a are disposed closer to the first side 103a than the second side 105a. The intermediate portions 49a of the second contact module 55b are disposed closer to the first side 103b than the second side 105b. The intermediate portions 49b of the first contact module 55a are disposed closer to the second side 105a than the first side 103a.

Accordingly, when the second and first contact modules 55b and 55a are disposed adjacent each other such that the second side 105b faces the first side 103a as illustrated in FIG. 10B with respect to the first and second contact modules 120a and 120b, the intermediate portions 49b and 49a of the first and second contact modules 120a and 120b, respectively, are spaced more closely than the intermediate portions 49a and 49b of the first and second contact modules 120a and 120b, respectively. The adjacent first and second pluralities of electrical contacts 46a and 46b of the first and second contact modules 120a and 120b along the common row direction 39, respectively, define ground contacts G. The adjacent second and first pluralities of electrical contacts 46b and 46a of the first and second contact modules 120a and 120b along the common row direction 39, respectively define signal contacts S. The adjacent signal contacts S along the common row direction 39 define differential signal pairs 122. Thus, it should be appreciated that the intermediate portions 49b and 49a of each differential pair 122 of adjacent signal contacts 46b and 46a of the first and second contact modules 120a and 120b, respectively, are spaced more closely than the intermediate portions 49a and 49b of each pair of adjacent ground contacts 46a and 46b of the first and second contact modules 120 and 120b, respectively. Alternatively, the signal contacts S could be provided as single-ended signal contacts.

None of the signal contacts S of the differential signal pairs 122 in the second contact configuration 126 is disposed immediately adjacent another signal contact. Rather, a ground contact G is disposed immediately adjacent the signal contacts S of each differential pair 122. For instance, a ground contact G can be disposed on both sides of the differential pair 122 in the respective row, and a ground contact G can be disposed on both sides of each signal contact C of the differential pair 122 in their respective columns 57. Thus, it can be said that the signal contacts S of a given differential pair 122 are surrounded by ground contacts G, thereby providing reduced cross-talk during operation.

Furthermore, when the first and second contact modules 55a and 55b are disposed adjacent each other such that the second side 105a faces the first side 103b as illustrated in FIG. 10B with respect to the third and fourth contact modules 120c and 120d, the intermediate portions 49b and 49a of the third and fourth contact modules 120c and 120c, respectively, are spaced more closely than the intermediate portions 49a and 49b of the third and fourth contact modules 120c and 120d, respectively. The adjacent first and second pluralities of electrical contacts 46a and 46b of the third and fourth contact modules 120a and 120b along the common row direction 39, respectively, define ground contacts G. The adjacent second and first pluralities of electrical contacts 46b and 46a of the third and fourth contact modules 120a and 120b along the common row direction 39, respectively define signal contacts S. The adjacent signal contacts S along the common row direction 39 define differential signal pairs 122. Thus, it should be appreciated that the intermediate portions 49b and 49a of each differential pair 122 of adjacent signal contacts 46b and 46a of the third contact modules 120a and 120b, respectively, are spaced more closely than the intermediate portions 49a and 49b of each pair of adjacent ground contacts 46a and 46b of the third and fourth contact modules 120 and 120b, respectively.

It should be appreciated that each of the four contact modules 120a-120d has a different contact configuration than each of the other of the four contact modules 120a- and 120d. The different contact configuration can be at least one of 1) a different assignment the signal and ground contacts with respect to a common column direction along the respective columns of each contact module, and 2) a placement of the electrical contacts in the contact modules.

For instance, the first contact module 120a is illustrated as the first contact module 55b, while the second and third contact modules 120b and 120c are each illustrated as the first contact module 55a. Thus, the row location of the first plurality of electrical contacts 46a of the first contact module 120a is different than the row location of the first plurality of electrical contacts 46a of the second and third contact modules 120b and 120c along their respective columns in the common column direction 53. Likewise, the row location of the second plurality of electrical contacts 46b of the first contact module 120a is different than the row location of the second plurality of electrical contacts 46b of the second and third contact modules 120b and 120c along their respective columns in the common column direction 53.

Additionally, the first contact module 120a has a different assignment of the signal and ground contacts with respect to the column direction 53 along the column 47a than the fourth contact module 120d along the column 47d. In particular, while the first and fourth contact modules 120a and 120d are both illustrated as second contact modules 55b (and thus have the same placement of electrical contacts in the respective contact modules along the column direction), each of the first plurality of electrical contacts 46a of the first contact module 120a is a ground contact G, while each of the first plurality of electrical contacts 46a of the fourth contact module 120d is a signal contact S. Likewise, each of the second plurality of electrical contacts 46b of the first contact module 120a is a signal contact S, while each of the second plurality of electrical contacts 46b of the fourth contact module 120d are is a ground contact G.

Because in FIG. 10B the signal contacts S of each differential signal pair 122 are disposed in different columns 53 and are disposed adjacent each other along the common row direction 39, the broadsides 104 of the signal contacts S face each other (see FIGS. 3B and 6B). Thus, it can be said that each of the differential signal pairs 122 is a broadside coupled differential signal pair.

The embodiments described in connection with the illustrated embodiments have been presented by way of illustration, and the present invention is therefore not intended to be limited to the disclosed embodiments. Furthermore, the structure and features of each the embodiments described above can be applied to the other embodiments described herein, unless otherwise indicated. Accordingly, those skilled in the art will realize that the invention is intended to encompass all modifications and alternative arrangements included within the spirit and scope of the invention, for instance as set forth by the appended claims.

What is claimed:

1. An electrical connector comprising:
a first contact module and a contact module adjacent the first contact module, each contact module having a plurality of first and second electrical contacts, each of the first and second electrical contacts including a mating portion, a mounting portion, and an intermediate portion extending between the mating portion and the mounting portion, such that in each contact module, the intermediate portions of the first electrical contacts are disposed in a first common plane and the intermediate portions of the second electrical contacts are disposed in a second common plane that is spaced from the first common plane,
wherein the first contact modules and the second contact modules are arranged such that two adjacent ones of the second electrical contacts of the first and second contact modules, respectively, are spaced more closely than the intermediate portions of two adjacent ones of the first electrical contacts of the first and second contact modules, respectively.

2. The electrical connector as recited in claim 1, wherein the first electrical contacts are ground contacts and the second electrical contacts are signal contacts, and the two adjacent ones of the signal contacts define a differential signal pair.

3. The electrical connector as recited in claim 2, wherein the signal contacts and the ground contacts are arranged in each contact module in an alternating pattern along a column direction.

4. The electrical connector as recited in claim 2, wherein the mounting portions of the signal contacts are offset with respect to the intermediate portions of the signal contacts, and the mounting portions of the ground contacts are offset with respect to the intermediate portions of the ground contacts.

5. The electrical connector as recited in claim 2, wherein the intermediate portions of the signal contacts are coplanar with the mounting portions of the signal contacts, and the intermediate portions of the ground contacts are coplanar with the mounting portions of the ground contacts.

6. The electrical connector as recited in claim 2, wherein the mating portions of the signal contacts and ground contacts are offset with respect to the intermediate portions of the signal and ground contacts, respectively.

7. The electrical connector as recited in claim 2, wherein the electrical connector comprises a receptacle connector having a housing that retains the first and second contact modules, the housing defines a plurality of aligned receptacle pockets that are also aligned with the mating portions of the ground contacts and the signal contacts such that the receptacle pockets are configured to receive corresponding header contacts that mate with the mating portions of the ground and signal contacts.

8. An electrical connector comprising:
a connector housing defining a plurality of receptacle pockets;
a first leadframe assembly retained by the connector housing and a second leadframe assembly carried by the connector housing at a location adjacent the first leadframe assembly, the first leadframe assembly including a first leadframe housing and a plurality of signal contacts retained by the first leadframe housing, the second leadframe assembly including a second leadframe housing and a plurality of ground contacts retained by the second leadframe housing, such that the signal and ground contacts are arranged in an alternating pattern along a column direction, each signal and ground contact including a mating portion, a mounting portion, and an intermediate portion extending between the mating portion and the mounting portion,
wherein the intermediate portions of the ground contacts are disposed in a first common plane and the intermediate portions of the signal contacts are disposed in a second common plane that is spaced from the first common plane, the mating portions of the ground contacts are offset with respect to the first common plane in a direction toward the second common plane, the mating portions of the signal contacts are offset with respect to the second common plane in a direction toward the first common plane, and each receptacle pocket is aligned with a select one of the mating portions of the signal contacts and the mating portions of the ground contacts.

9. The electrical connector as recited in claim 8, wherein the electrical connector comprises a receptacle connector having aligned receptacle pockets configured to receive respective header contacts of a complementary header connector that mate with the mating portions of the signal and ground contacts, wherein the receptacle pockets are aligned with the mating portions of the signal contacts and ground contacts.

10. An electrical connector comprising:
a first contact module, a second contact module disposed immediately adjacent the first contact module along a row direction, and a third contact module disposed immediately adjacent the second contact module along the row direction such that the second contact module is disposed between the first and the third contact modules, each of the first, second, and third contact modules including a plurality of electrical contacts spaced along respective columns, at least one of which is a signal contact and at least one of which is a ground contact;
wherein the electrical contacts of the first contact module are arranged in a first pattern along a column direction, the electrical contacts of the second contact module are arranged in a second pattern that is different than the first pattern along the column direction, and the electrical contacts of the third contact module are arranged in the second pattern.

11. The electrical connector as recited in claim 10, wherein the signal contact of the second contact module and the signal contact of the third contact module define a differential signal pair.

12. The electrical connector as recited in claim 10, further comprising a fourth contact module disposed immediately adjacent the third contact module such that the third contact module is disposed between the second contact module and the fourth contact module, the fourth contact module including a plurality of electrical contacts spaced along a respective column, at least one of which is a signal contact and at least one of which is a ground contact, wherein the electrical contacts of the fourth contact module are arranged in the first pattern along the column direction.

13. The electrical connector as recited in claim 10, wherein the ground contacts and signal contacts are disposed at respective first locations in the first pattern, and the ground contacts and signal contacts are disposed at respective second locations in the second pattern, wherein the second locations are different than the first locations.

14. An electrical connector comprising:
a connector housing;
a first contact module, a second contact module, a third contact module, and a fourth contact module, each contact module including a contact module housing and a plurality of electrical contacts including a plurality of ground contacts and a plurality of signal contacts, wherein each contact module has a different contact configuration than each of the other contact modules.

15. The electrical connector as recited in claim 14, wherein the electrical contacts of each contact module are spaced along a respective column, and the contact configuration comprises at least one of 1) a different assignment the signal and ground contacts with respect to a common column direction along the respective columns of each contact module, and 2) a placement of the electrical contacts in the contact modules.
